(19) United States
(12) Patent Application Publication
(10) Pub. No.: US 2026/0187347 A1
(43) Pub. Date: Jul. 2, 2026

(54) System and Method for Real-Time Script Analysis and Narrative Scoring in a Structured Editing Environment

(71) Applicant: Modus Novus, Inc, Davenport, FL (US)

(72) Inventor: Kenneth M. Greenwood, Davenport, FL (US)

(21) Appl. No.: 19/276,012

(22) Filed: Jul. 22, 2025

(51) Int. Cl. G06F 40/166; G06F 40/205; G06F 40/284

(52) U.S. Cl. CPC G06F 40/166; G06F 40/205; G06F 40/284

(57) ABSTRACT

A system and method for providing real-time narrative analysis and scoring within a structured screenwriting environment, integrates directly with a script editor to continuously evaluate screenplay content as it is written, using a modular AI scoring engine based on predefined rubrics that assess multiple narrative and commercial dimensions, including pacing, genre alignment, demographic appeal, artistic merit, cultural volatility, ideological alignment, and formatting compliance.

### FIELD OF INVENTION

This invention relates to the fields of computer-assisted writing, artificial intelligence, natural language processing, and script development tools.

### BACKGROUND

Traditional screenwriting tools such as Final Draft, Celtx, and WriterDuet have focused primarily on formatting, collaboration, and compliance with industry-standard screenplay structures. While these platforms support the mechanical aspects of screen creation, they do not offer real-time, data-driven guidance on the narrative quality, audience appeal, market viability, or cultural risk of the script content as it is being written.

Writers and studios often rely on subjective manual feedback, script coverage services, or post-draft analyses to assess script strength. These methods are time-consuming, inconsistent, and reactive—delivering insights only after substantial effort has already been invested. Furthermore, they lack integration with modern AI capabilities that can interpret genre conventions, character arcs, emotional pacing, and demographic resonance at scale.

While AI-based tools have begun to assist with general writing (e.g., grammar correction, tone analysis, or prose generation), there is no existing system that integrates real-time narrative evaluation and scoring directly within a structured script editor, especially not one calibrated to the specialized needs of professional screenwriting.

This invention addresses that gap by embedding a live, intelligent scoring engine inside the screenwriting process itself—providing continuous, multi-dimensional feedback while the writer composes scenes, dialogues, and story beats. It transforms the script editor from a passive format-checker into an active, intelligent creative collaborator.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a system and method for performing real-time evaluation, scoring, and feedback of screenplays and narrative scripts within a structured editing environment, such as screenwriting software.

The invention applies AI-based analysis to live user inputs, enabling the dynamic assessment of narrative elements including pacing, structure, audience alignment, cultural risk, and market potential. It enhances creative authoring tools by providing an intelligent recommendation system, offering practical utility for writers, producers, studios, and development executives.

According to the invention there is provided a system and method for real-time script analysis and narrative scoring within a structured screenwriting environment.

Preferably, the system integrates directly with screenplay editing software to deliver live feedback, multi-dimensional scoring, and creative recommendations as the user writes.

The system comprises:
A script parsing and formatting engine capable of recognizing standard screenplay structure (e.g., scene headings, dialogue, action blocks),
one or more domain-specific scoring modules, each focused on a narrative axis such as:
   A Genre Assessment Module, which identifies and classifies the dominant genre(s) based on structural and thematic patterns, and adjusts scoring benchmarks accordingly,
   A 4-Quadrant Appeal Score, which estimates resonance with each of the four marketing demographics (Male/Female, and Over 25 years/25 or below) and flags limitations in broad market appeal,
   An Artistic Score, which evaluates the script's creative ambition, originality, emotional depth, and thematic cohesion on an objective rubric,
   A Genre-Specific Artistic Score, which assesses the work's artistic merit relative to genre conventions and expectations (e.g., visual inventiveness in sci-fi, character intimacy in drama, etc.),
   Script Format Compliance, which flags formatting deviations, structure violations, or submission-readiness issues that may disqualify the script during studio or festival intake.
   A Story Pacing Protocol (SPP), which evaluates tempo, beat timing, and scene rhythm,
   An Audience Resonance Protocol (ARP), which estimating emotional impact and demographic alignment,
   A Cultural Volatility Index (CVI), which measuring ideological sensitivity and polarization risk,
   A Wokeness Score, which gauges progressive alignment and potential reception across political spectra, and
   A Commercial Potential Score, which estimates market fit, packaging strength, and genre viability, the system further comprising
A real-time user interface (UI) element integrated into the editor, displaying live scoring, warnings, or improvement suggestions.

The system may include rewrite tools and scene-specific diagnostics, guiding structural revisions or character balancing.

Key capabilities include:
Live scene-by-scene evaluation as the user types or revises,
Feedback based on historical genre norms, audience data, and proprietary narrative models, and
A modular rubric architecture, allowing studios or users to prioritize different evaluation axes.

By delivering real-time, actionable insights inside the creative environment, this invention allows screenwriters and development teams to make more informed, strategic, and commercially aware, creative decisions at the moment of composition—not after the fact.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of one embodiment of a system architecture, in accordance with embodiments of the invention.

FIG. 2 illustrates an example of an implementation of an integrated User Interface used by the system, in accordance with embodiments of the invention.

FIG. 3 illustrates one embodiment of a real-time scoring pipeline flowchart, in accordance with embodiments of the invention.

FIG. 4 illustrates a bar chart implementation of a scene-by-scene scoring visualization, in accordance with embodiments of the invention.

FIG. 5 illustrates a graph implementation of a scene-by-scene scoring visualization, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

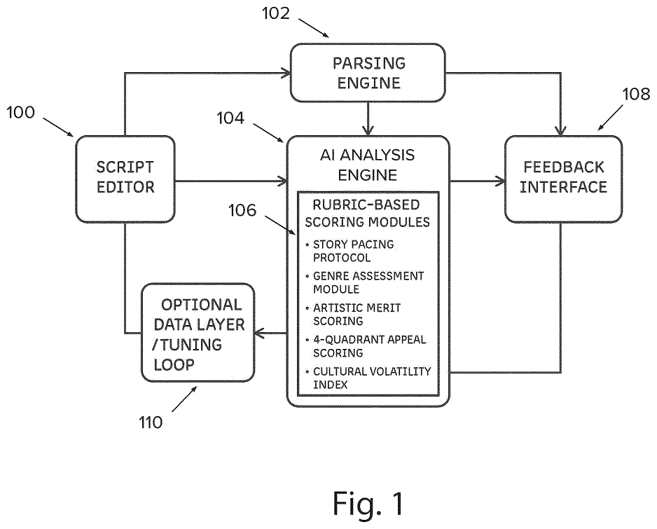

FIG. 1 refers a block diagram of a system architecture overview of one implementation of the invention, which includes: a structured script editor 100, a real-time parser 102 (also referred to herein as a parsing engine), an AI analysis engine 104, with a rubric-based scoring module 106 (Story Pacing Protocol (SPP), Genre Assessment Module, Artistic Merit Scoring, 4-Quadrant Appeal Scoring, CVI (Cultural Volatility Index), etc.), a feedback interface module 108 and, in this embodiment, a cloud-based training/refinement loop 110 (also referred to herein as Data Layer Tuning Loop, which is not included in all embodiments, and is optional.

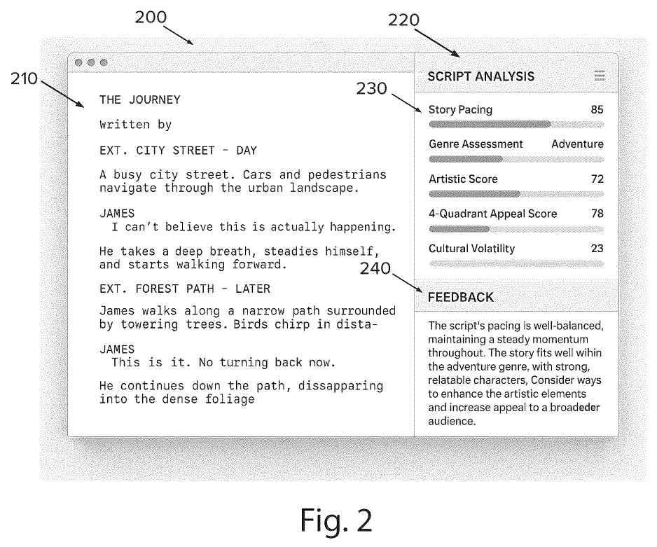

FIG. 2 shows one embodiment of an integrated user interface 200. The interface comprises a script editor panel 210 displaying screenplay content and a script analysis sidebar 220. The sidebar includes live scene scores for multiple axes 230 (Story Pacing, Genre Assessment, Artistic Score, Quadrant Appeal, Cultural Volatility), and a written feedback section 240 summarizing narrative strengths and suggestions.

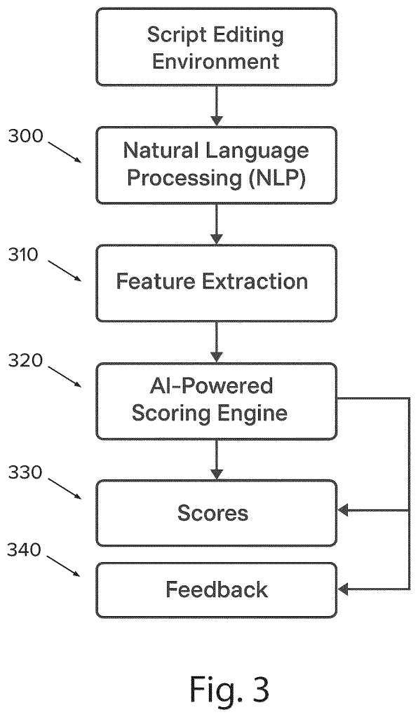

FIG. 3 shows one embodiment of a real-time scoring pipeline. In this design, natural language processing (NLP) 300 is applied to extract key narrative features 310, which are then fed into an AI-powered scoring engine 320. The scoring engine generates narrative metrics, which include scores 330 which are passed to modules responsible for computing feedback 340 and displaying scores to the user.

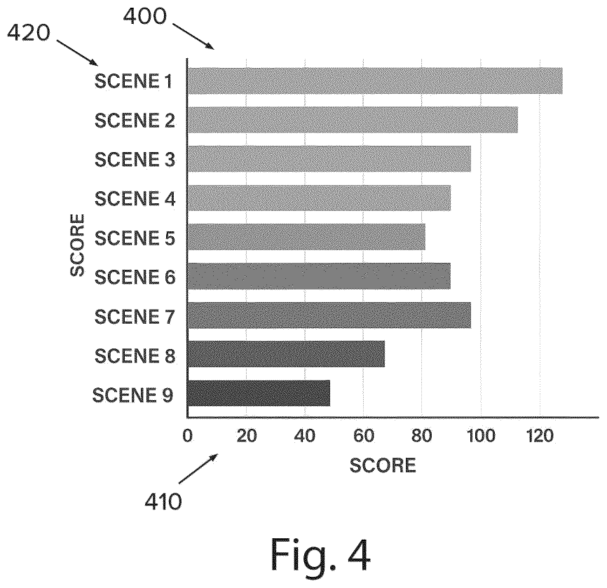

FIG. 4 shows a bar chart implementation 400 of a scene-by-scene scoring visualization in graph form, showing: narrative metrics defined in terms of scores 410 over time 420 (scene-by-scene in this example) based on: a pacing curve, tonal volatility, quadrant fit, and based on a comparison against genre-specific benchmarks.

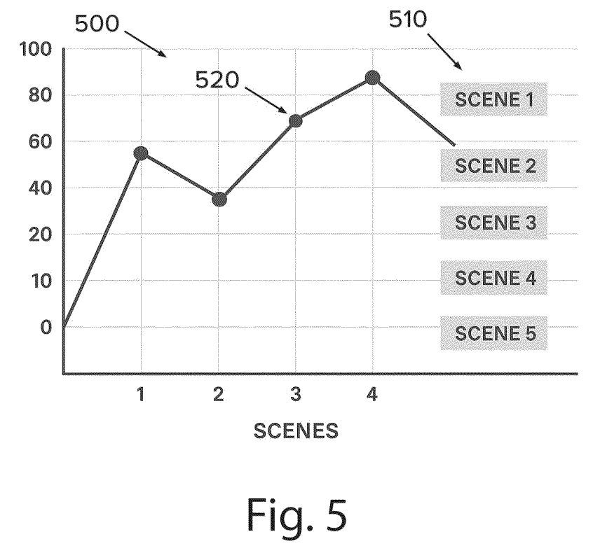

FIG. 5 shows a graph implementation 500 of a scene-by-scene 510 scoring visualization, again showing the scores 520 for each scene based on: a pacing curve, tonal volatility, quadrant fit, and based on a comparison against genre-specific benchmarks.

### System Architecture

The system in one implementation comprises the following components:

### (a) Structured Script Editor 100

The script editor 100 provides the environment where the user composes or imports a screenplay or other narrative script using standard screenplay formatting conventions (e.g., scene headers, dialogue, action blocks). This can be implemented as:
A native screenwriting platform (e.g., Final Draft)
A plug-in or extension for third-party editors
A custom browser-based editor

### (b) Parsing Engine 102

The parsing engine 102 (also referred to as the real-time script parser) tokenizes and classifies elements of the screenplay into recognizable categories (e.g., scene, action, dialogue, character entry) in real time. This engine enables:
Scene boundary detection
Beat identification
Character activity tracking

### (c) Ai Analysis Engine 104 With Rubric-based Scoring Module 106

The AI analysis engine 104 is the core evaluation component that works in conjunction with a rubric-based scoring module 106 to assess narrative inputs. The scoring module includes specific evaluative components, referred to as narrative scoring protocols or modules, such as:
Story Pacing Protocol (SPP)—evaluates narrative tempo, beat rhythm, and structural pacing
Genre Assessment Module—detects dominant/secondary genres using narrative and structural cues
Artistic Merit Scoring—assesses originality, symbolic density, thematic strength, and emotional resonance
4-Quadrant Appeal Scoring—estimates demographic alignment with four key market sectors (Men/Women, Over/Under 25)
Cultural Volatility Index (CVI)—measures ideological sensitivity and potential for polarized audience response

Additional rubric dimensions that may be applied within this module (though not explicitly depicted in the drawing) include:
Audience Resonance Protocol (ARP)—measures emotional impact and demographic fit
Genre-specific Artistic Scoring—evaluates artistic strength against genre-specific norms
Script Format Validation—checks compliance with industry-standard formatting
Wokeness Score—flags tonal shifts and progressive ideological alignment
Commercial Potential Rubric—estimates market fit, packaging strength, and genre viability

These modules may be implemented independently or as weighted components depending on use case or studio preference.

### (d) Feedback Interface 108

The feedback interface 108 is the output and display component that delivers real-time scoring results and narrative feedback directly to the user, typically in a sidebar, overlay, or modular dashboard. This interface(
Shows live numeric or qualitative scores per scene or act
Provides visual alerts such as tonal spikes or pacing stalls
Offers context-sensitive rewrite suggestions

### (e) Optional Data Layer/Tuning Loop 110

The optional data layer and tuning loop 110 (also referred to as the cloud-based training/refinement loop) allows adaptive calibration of scoring modules based on historical user interactions, studio development feedback, or market trend data. In some implementations, this module includes an API for accessing anonymized trend analytics or benchmarking across projects.

### Method of Operation

1. Script Input

The user begins writing or loads an existing script into the editor 100.
2. Live Parsing

As the user writes, the system continuously parses input into discrete narrative components (scenes, dialogue blocks, actions) using the parsing and segmentation engine 102.
3. Segment Evaluation

Using the Analysis engine 104 and Scoring Module 106, each parsed segment is analyzed by one or more scoring modules. For example:
A long, static dialogue block may reduce the pacing score.
A controversial topic may increase CVI risk.
A well-timed action beat may enhance audience appeal for the 18-34-year-old demographic.
4. Real-time Feedback

Scores and alerts are updated dynamically in the user interface (UI). Writers may, for example, be provided with feedback messages such as:
“This beat is slowing momentum relative to genre average”
“This character has less than 10% of dialogue across the last 20 pages”
“This scene aligns strongly with Gen Z values”
5. Adaptive Rewrite Mode based on the feedback interface module 108 is an optional feedback provided in some implementations.

The user may activate a mode that performs one or more of:
Highlights weak areas by score,
Offers ranked rewrite suggestions, and
Simulates demographic responses to alternative phrasing.

### Customization and Extensibility

Rubric Weighting—Studios or writers can adjust scoring emphasis (e.g., prioritize Commercial Potential over Cultural Volatility).
Genre Templates—Rubrics can be fine-tuned for specific genres (e.g., horror requires different pacing than drama).
Data Sync—Scripts may be evaluated in batches, e.g., for review by producers, enabling AI-assisted development notes.

The system and method described above were described with respect to specific implementations and using specific modules. It will be appreciated that the nature of the narrative input and the choice of models in implementing the system may vary depending on the needs, without departing from the scope of the invention.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for real-time narrative analysis and scoring within a structured script-editing environment, implemented in software code that includes logical modules, comprising:
a script editor interface configured to receive inputs by composing or importing a narrative script,
a real-time parsing and segmentation engine that tokenizes and classifies elements of the script into recognizable categories in real time, a modular AI-driven scoring engine evaluating each element of the script using defined rubrics aligned to narrative, commercial, and social dimensions, and
a feedback display module integrated into the script editor interface, wherein the system continuously evaluates inputs into the script editor interface and provides live scoring and narrative feedback based on the defined rubrics.

2. The system of claim 1, wherein the recognizable categories that the parsing and segmentation engine classifies elements of the script into, include one or more of scene, action, dialogue, and character entry.

3. The system of claim 1, wherein the scoring engine evaluates inputs across multiple defined scoring rubrics, including one or more of: pacing, audience resonance, genre classification, artistic merit, quadrant appeal, cultural volatility, ideological alignment, and commercial viability.

4. The system of claim 1, wherein the defined scoring rubrics comprise one or more of:
automatic detection of dominant and secondary genres,
analysis of demographic quadrant alignment and generation of quadrant heatmaps,
assessment of originality, symbolic density, thematic ambition, and emotional depth,
application of genre-specific artistic standards,
validation of script format compliance,
evaluation of story pacing and structural rhythm,
estimation of audience resonance by demographic group,
detection of cultural volatility and ideological triggers,
measurement of progressive tone alignment, and
estimation of commercial potential based on genre conventions and market fit.

5. The system of claim 2, wherein the scoring engine dynamically adjusts its evaluation criteria based on detected or declared script genres, using genre-specific benchmarks and weighting schemes.

6. The system of claim 1, wherein the feedback display module provides one or more of: live score updates per scene or segment, visual indicators of narrative imbalance, and suggestions for structural or tonal improvements based on the defined rubrics.

7. The system of claim 4, further comprising a demographic modeling module that forecasts likely audience resonance for each script element across four major demographic quadrants, that include women over 25 years, women 25 years or under, men over 25 years, and men 25 years or under, and flags potential appeal gaps.

8. The system of claim 1, wherein the script parsing engine also detects deviations from industry-standard formatting rules and issues real-time alerts to the user.

9. The system of claim 1, further comprising a recommendation engine that, based on detected scoring weaknesses, proposes alternative scene structures, pacing adjustments, or character distribution changes.

10. A method of evaluating screenplay content in real time, comprising the steps of:
parsing script input into structural units,
classifying those units by type,
applying AI-derived rubric scores to each unit,
aggregating scores and detecting deviation from genre or market norms, and
displaying said scores to the user via the script editor interface.

11. The method of claim 10, wherein the types of units include: scene, action, dialogue, character entry, parenthetical, transition, and slugline.
